(19) United States
(12) Patent Application Publication
(10) Pub. No.: US 2026/0321177 A1
(43) Pub. Date: Oct. 15, 2026

(54) GAMMA TUNING METHOD AND GAMMA TUNING DEVICE FOR DISPLAY DEVICE, AND DISPLAY DEVICE

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Qi Liu, Beijing (CN); Yong Yu, Beijing (CN)

(73) Assignees: Chengdu BOE Optoelectronics Technology Co., Ltd., Chengdu, Sichuan (CN); BOE TECHNOLOGY GROUP CO., LTD., Beijing (CN)

(21) Appl. No.: 18/838,464

(22) PCT Filed: Dec. 11, 2023
(86) PCT No.: PCT/CN2023/137815

§ 371 Date: Aug. 14, 2024

(51) Int. Cl. G09G 3/20; G01J 1/42

(52) U.S. Cl. CPC G09G 3/2007; G01J 1/42; G01J 2001/4247; G09G 2320/0223; G09G 2320/0673; G09G 2360/16

(57) ABSTRACT

A gamma tuning device for a display device is provided, including: a target brightness acquisition module configured to acquire a first target brightness interval and a first grayscale interval in first display mode and a second target brightness interval and a second grayscale interval in second display mode, a maximum target brightness in first target brightness interval is greater than a maximum target brightness in second target brightness interval; a gamma tuning module configured to perform gamma tuning for target brightness in first target brightness interval and grayscales in first grayscale interval to obtain first set of gamma values; and a gamma calculation module configured to calculate, for target brightness in the second target brightness interval and grayscales in the second grayscale interval, second set of gamma values based on first set of gamma values according to relationship between the first target brightness interval and the second target brightness interval.

### CROSS-REFERENCE TO RELATED APPLICATION

This application is a Section 371 National Stage Application of International Application No. PCT/CN2023/137815, filed on Dec. 11, 2023, entitled “GAMMA TUNING METHOD AND GAMMA TUNING DEVICE FOR DISPLAY DEVICE, AND DISPLAY DEVICE”, the content of which is hereby incorporated by reference in its entirety.

### TECHNICAL FIELD

The present disclosure relates to the field of display technology, and in particular to a gamma tuning method and a gamma tuning device for a display device, and a display device.

### BACKGROUND

In the field of display technology, after a display panel is manufactured, it is generally to modulate brightness for various grayscales using a gamma curve, so as to achieve an accurate restoration of different brightness in an image displayed on the display panel. How to make the display panel more accurate in displaying with different brightness in the image is an important topic in the field of display technology research.

It should be noted that the above information disclosed in this section is just for understanding of the background of the present disclosure. Therefore, the above information may contain information that does not constitute a related art known to those skilled in the art.

### SUMMARY

In an aspect, a gamma tuning device for a display device is provided, the display device has a first display mode and a second display mode, the display device uses a first display region to display in the first display mode and uses a second display region to display in the second display mode, and an area of the first display region is less than an area of the second display region; the gamma tuning device including: a target brightness acquisition module configured to acquire a first target brightness interval and a first grayscale interval in the first display mode and a second target brightness interval and a second grayscale interval in the second display mode, a maximum target brightness in the first target brightness interval is a first maximum target brightness, a maximum target brightness in the second target brightness interval is a second maximum target brightness, and the second maximum target brightness is less than the first maximum target brightness; a gamma tuning module configured to perform gamma tuning for a plurality of target brightness in the first target brightness interval and a plurality of grayscales in the first grayscale interval to obtain a first set of gamma values, where the first set of gamma values includes n gamma values, and the n gamma values include an i^{th} gamma value mapping an i^{th} brightness in the first target brightness interval and an i^{th} grayscale in the first grayscale interval, where n is a positive integer greater than or equal to 2, and i is a positive integer greater than or equal to 1 and less than or equal to n; and a gamma calculation module configured to calculate, for a plurality of target brightness in the second target brightness interval and a plurality of grayscales in the second grayscale interval, a second set of gamma values based on the first set of gamma values according to a relationship between the first target brightness interval and the second target brightness interval, where the calculating a second set of gamma values based on the first set of gamma values includes: determining the i^{th} gamma value corresponding to the i^{th} grayscale in the first grayscale interval as a j^{th} gamma value corresponding to a j^{th} grayscale in the second grayscale interval, where j is a positive integer greater than or equal to 1 and less than or equal to n, and i is not equal to j.

According to some exemplary embodiments, a maximum grayscale in the second grayscale interval is an n^{th} grayscale; and the gamma calculation module ia configured to calculate a second set of gamma values based on the first set of gamma values according to a relationship between the first target brightness interval and the second target brightness interval by: determining, by the gamma calculation module, an m^{th} first gamma value corresponding to an m^{th} grayscale in the first grayscale interval as an n^{th} second gamma value corresponding to an n^{th} grayscale in the second grayscale interval according to a relationship between the first maximum target brightness and the second maximum target brightness, where m is a positive integer less than n; and determining, by the gamma calculation module, the i^{th} first gamma value corresponding to the i^{th} grayscale in the first grayscale interval as the j^{th} second gamma value corresponding to the j^{th} grayscale in the second grayscale interval according to an equation of:

$$i = round [ ( j - 1 ) / ( n - 1 ) \times ( m - 1 ) ] + 1 ,$$

where round ( ) is a rounding function.

According to some exemplary embodiments, the gamma calculation module is configured to calculate m according to an equation of:

$$m = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the gamma tuning module is further configured to divide the first grayscale interval into a first grayscale sub-interval and a second grayscale sub-interval, the first grayscale sub-interval includes a first grayscale to an x^{th} grayscale, the second grayscale sub-interval includes an (x+1)^{th} grayscale to an nth grayscale, and x is an integer greater than or equal to 2 and less than or equal to n−1; the gamma tuning device further includes a lighting module configured to drive the display device to display a predetermined screen; and the gamma tuning module is configured to perform gamma tuning for a plurality of target brightness in the first target brightness interval and a plurality of grayscales in the first grayscale interval by: driving, by the lighting module, the display device to display using a third display region, and performing, by the gamma tuning module, gamma tuning respectively for a plurality of grayscales in the first grayscale sub-interval; and driving, by the lighting module, the display device to display using a fourth display region, and performing, by the gamma tuning module, gamma tuning respectively for a plurality of grayscales in the second grayscale sub-interval, where an area of the third display region is greater than an area of the fourth display region.

According to some exemplary embodiments, the gamma tuning module is further configured to calculate x by an equation of:

$$x = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the area of the third display region is equal to the area of the second display region; and/or the area of the fourth display region is greater than or equal to the area of the first display region.

According to some exemplary embodiments, the lighting module is configured to drive the display device to display using a third display region further by: compensating a voltage signal of the third display region by using a first voltage drop compensation parameter; and the lighting module is configured to drive the display device to display using a fourth display region further by: compensating a voltage signal of the fourth display region by using a second voltage drop compensation parameter, and the first voltage drop compensation parameter is greater than the second voltage drop compensation parameter.

According to some exemplary embodiments, the lighting module is configured to drive the display device to display using a fourth display region and the gamma tuning module is configured to perform gamma tuning respectively for a plurality of grayscales in the second grayscale sub-interval by at least: driving, by the lighting module, the display device to display using the fourth display region and compensate the voltage signal of the fourth display region by using an a^{th} second voltage drop compensation parameter, and performing, by the gamma tuning module, gamma tuning for an a^{th} grayscale; and driving, by the lighting module, the display device to display using the fourth display region and compensate the voltage signal of the fourth display region by using a b^{th} second voltage drop compensation parameter, and performing, the gamma tuning module gamma tuning for a b^{th} grayscale, where x+1≤a<b≤n, a and b are integers, and the a^{th} second voltage drop compensation parameter is greater than the b^{th} second voltage drop compensation parameter.

According to some exemplary embodiments, the gamma tuning device further includes a brightness testing module configured to measure a display brightness of the display device; the gamma tuning module is further configured to determine at least two binding point grayscales in the first grayscale interval, and determine remaining grayscales other than the binding point grayscales as non-binding point grayscales; and the gamma tuning module is configured to perform gamma tuning for a plurality of target brightness in the first target brightness interval and a plurality of grayscales in the first grayscale interval to obtain a first set of gamma values by: performing. by the gamma tuning module, gamma tuning for each binding point grayscale to obtain a gamma value, so that a difference between a display brightness measured by the brightness testing module and a target brightness acquired by the target brightness acquisition module at the binding point grayscale of the display device is less than a predetermined value; and calculating, by the gamma tuning module, a gamma value of each non-binding point grayscale according to a gamma value of each binding point grayscale.

According to some exemplary embodiments, the gamma tuning module is configured to perform gamma tuning for each binding point grayscale to obtain a gamma value by: perform, by the gamma tuning module, gamma tuning for the binding point grayscales sequentially in an ascending order of grayscale value.

According to some exemplary embodiments, the target brightness of a maximum binding point grayscale is less than an upper limit value of a testing range of the brightness testing module.

According to some exemplary embodiments, the gamma tuning module is further configured to obtain a gamma value corresponding to each non-binding point grayscale greater than the maximum binding point grayscale through interpolation calculation according to the gamma value corresponding to each binding point grayscale.

According to some exemplary embodiments, the gamma tuning device further includes a brightness attenuation module between a light-emitting surface of the display device and the brightness testing module, and the brightness attenuation module is configured to perform a brightness attenuation on a light ray emitted by the display device according to a predetermined brightness attenuation coefficient before the light ray is emitted to the brightness testing module; and a product of the target brightness of a maximum binding point grayscale and the brightness attenuation coefficient is less than an upper limit of a testing range of the brightness testing module.

In another aspect, a gamma tuning method for a display device is provided, where the display device has a first display mode and a second display mode, the display device uses a first display region to display in the first display mode and uses a second display region to display in the second display mode, and an area of the first display region is less than an area of the second display region; the gamma tuning method including: acquiring a first target brightness interval and a first grayscale interval in the first display mode, where a maximum target brightness in the first target brightness interval is a first maximum target brightness; performing gamma tuning for a plurality of target brightness in the first target brightness interval and a plurality of grayscales in the first grayscale interval to obtain a first set of gamma values, where the first set of gamma values includes n gamma values, and the n gamma values include an i^{th} gamma value mapping an i^{th} brightness in the first target brightness interval and an i^{th} grayscale in the first grayscale interval, where n is a positive integer greater than or equal to 2, and i is a positive integer greater than or equal to 1 and less than or equal to n; acquiring a second target brightness interval and a second grayscale interval in the second display mode, where a maximum target brightness in the second target brightness interval is a second maximum target brightness, and the second maximum target brightness is less than the first maximum target brightness; and calculating, for a plurality of target brightness in the second target brightness interval and a plurality of grayscales in the second grayscale interval, a second set of gamma values based on the first set of gamma values according to a relationship between the first target brightness interval and the second target brightness interval, where the calculating a second set of gamma values based on the first set of gamma values includes: determining the i^{th} gamma value corresponding to the i^{th} grayscale in the first grayscale interval as a j^{th} gamma value corresponding to a j^{th} grayscale in the second grayscale interval, where j is a positive integer greater than or equal to 1 and less than or equal to n, and i is not equal to j.

According to some exemplary embodiments, a maximum grayscale in the second grayscale interval is an n^{th} grayscale; and the calculating a second set of gamma values based on the first set of gamma values according to a relationship between the first target brightness interval and the second target brightness interval includes: determining an m^{th} first gamma value corresponding to an m^{th} grayscale in the first grayscale interval as an n^{th} second gamma value corresponding to an n^{th} grayscale in the second grayscale interval according to a relationship between the first maximum target brightness and the second maximum target brightness, where m is a positive integer less than n; and determining the i^{th} first gamma value corresponding to the i^{th} grayscale in the first grayscale interval as the j^{th} second gamma value corresponding to the j^{th} grayscale in the second grayscale interval according to an equation of:

$$i = round [ ( j - 1 ) / ( n - 1 ) \times ( m - 1 ) ] + 1 ,$$

where round ( ) is a rounding function.

According to some exemplary embodiments, m is calculated according to an equation of:

$$m = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the first grayscale interval includes a first grayscale sub-interval and a second grayscale sub-interval, the first grayscale sub-interval includes a first grayscale to an x^{th} grayscale, the second grayscale sub-interval includes an (x+1)^{th} grayscale to an n^{th} grayscale, and x is an integer greater than or equal to 2 and less than or equal to n−1; the performing gamma tuning for a plurality of target brightness in the first target brightness interval and a plurality of grayscales in the first grayscale interval includes: driving the display device to display using a third display region, and performing gamma tuning respectively for a plurality of grayscales in the first grayscale sub-interval; and driving the display device to display using a fourth display region, and performing gamma tuning respectively for a plurality of grayscales in the second grayscale sub-interval, where an area of the third display region is greater than an area of the fourth display region.

According to some exemplary embodiments, x is calculated by an equation of:

$$x = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

In another aspect, a display device is provided, including a display panel and a driver chip bound to the display panel, where the driver chip is programmed with a first set of gamma values and a second set of gamma values obtained by tuning of the gamma tuning device described above.

### BRIEF DESCRIPTION OF DRAWINGS

By describing in detail exemplary embodiments of the present disclosure with reference to the accompanying drawings, features and advantages of the present disclosure will become more apparent.

FIG. 1 shows a flowchart of a gamma tuning method for a display device according to the embodiments of the present disclosure.

FIG. 2 shows a schematic diagram of a principle of interpolation calculation used in the gamma tuning method for the display device according to the embodiments of the present disclosure.

FIG. 3 shows a schematic diagram of a gamma tuning device for a display device according to the embodiments of the present disclosure.

FIG. 4 shows a schematic diagram of another gamma tuning device for a display device according to the embodiments of the present disclosure.

FIG. 5 shows a schematic diagram of a principle of a brightness attenuation module performing a brightness attenuation in a gamma tuning device for a display device according to the embodiments of the present disclosure.

It should be noted that for the sake of clarity, in the accompanying drawings used to describe the embodiments of the present disclosure, sizes of layers, structures or regions may be enlarged or reduced, that is, these accompanying drawings are not drawn according to actual scale.

### DETAILED DESCRIPTION

In the following description, for the purpose of explanation, many specific details are set forth to provide comprehensive understanding of various exemplary embodiments. However, it is obvious that various exemplary embodiments may be implemented without these specific details or with one or more equivalent arrangements. In other cases, well-known structures and devices are shown in block diagrams in order to avoid unnecessarily obscuring the various exemplary embodiments. In addition, the various exemplary embodiments may be different, but need not be exclusive. For example, without departing from the inventive concept, a specific shape, configuration and characteristic of an exemplary embodiment may be used or implemented in another exemplary embodiment.

In the accompanying drawings, for clarity and/or description purposes, sizes and relative sizes of elements may be enlarged. Accordingly, the size and relative size of each element need not to be limited to those shown in the accompanying drawings. When the exemplary embodiments may be implemented differently, the specific process sequence may be different from the sequence described. For example, two consecutively described processes may be performed substantially simultaneously or in a reverse order. In addition, the same reference numeral represents the same element.

When an element is described as being “on”, “connected to” or “coupled to” another element, the element may be directly on the another element, directly connected to the another element, or directly coupled to the another element, or an intermediate element may be provided. However, when an element is described as being “directly on”, “directly connected to” or “directly coupled to” another element, no intermediate element is provided. Other terms and/or expressions used to describe the relationship between elements, for example, “between” and “directly between”, “adjacent” and “directly adjacent”, “on” and “directly on”, and so on, should be interpreted in a similar manner. In addition, the term “connection” may refer to a physical connection, an electrical connection, a communication connection, and/or a fluid connection. In addition, X-axis, Y-axis and Z-axis are not limited to three axes of a rectangular coordinate system, and may be interpreted in a broader meaning. For example, the X-axis, the Y-axis and the Z-axis may be perpendicular to each other, or may represent different directions that are not perpendicular to each other. For objectives of the present disclosure, “at least one selected from X, Y or Z” and “at least one selected from a group consisting of X, Y and Z” may be interpreted as only X, only Y, only Z, or any combination of two or more of X, Y and Z, such as XYZ, XY, YZ and XZ. As used herein, the term “and/or” includes any and all combinations of one or more of the listed related items.

It should be understood that, although terms “first”, “second” and so on may be used herein to describe different elements, those elements should not be limited by those terms. Those terms are just used to distinguish one element from another element. For example, without departing from the scope of the exemplary embodiments, a first element may be named as a second element, and similarly, a second element may be named as a first element.

With a development of display technology, people have an increasing demand for display brightness of display devices. For example, based on requirements of maximum brightness promotion, or fingerprint requirements, or requirements of overall high-contrast effect, a display device needs to achieve local high brightness, that is, the display device needs to have a local high brightness mode (Local HBM). Furthermore, a display device typically has a high brightness mode (HBM), which is a display mode that is triggered when the display device is in sunlight or other profiles. Therefore, for the two different display modes, namely HBM and Local HBM, it generally requires tuning with two sets of different gamma segments separately, which takes a long time and affects a production efficiency.

FIG. 1 shows a flowchart of a gamma tuning method for a display device according to the embodiments of the present disclosure.

The display device has a first display mode and a second display mode. The display device uses a first display region to display in the first display mode, and uses a second display region to display in the second display mode. An area of the first display region is less than an area of the second display region.

For example, the first display mode is Local HBM, and the area of the first display region is a part of the entire display region. According to actual display requirements of the display device, for example, the area of the first display region is 1%, 2%, 3%, 4%, 5%, 6%, 7% or 8% of the entire display region. The second display mode is HBM, and the second display region is the entire display region.

For example, the display device may be an organic light emitting diode (OLED) display device, a micro light emitting diode (Micro LED) display device, a quantum dot light emitting diode (QLED) display device, a liquid crystal display (LCD) display device, etc. An OLED display device is illustrated below as an example of the display device. The OLED display device may be, for example, a mobile phone, a tablet computer, etc., which will not be listed one by one here.

For example, the display device generally has a plurality of different display modes. Taking a mobile phone as an example, in addition to the HBM and the Local HBM mentioned above, a mobile phone usually has other display modes, such as three always on display (AOD) modes and nine normal modes (NOR), and each display mode corresponds to a gamma value.

Referring to FIG. 1, the gamma tuning method for the display device may include step S1010 to step S1040.

In step S1010, a first target brightness interval and a first grayscale interval in a first display mode are acquired, where a maximum target brightness in the first target brightness interval is a first maximum target brightness.

For example, Grayscale refers to the number of shades of a color from dark to light, and the more brightness changes in a color, the more grayscale it has. Grayscale levels of a display device mainly depend on a number of digital to analog conversion bits of a system. For example, an 8-bit processing system has grayscale levels of 2 to the power of 8, i.e., 256 grayscale levels, which means 256 brightness changes from black to white. In addition, the grayscale levels of the display device may also be 64, 512, 1024, etc., which will not be listed one by one here.

For example, the first grayscale interval includes a first grayscale, a second grayscale . . . an (n−1)^{th} grayscale, and an n^{th} grayscale. The 1^{st} grayscale has a grayscale value of 0, the 2^{nd} grayscale has a grayscale value of 1, and the n^{th} grayscale has a grayscale value of n−1.

For example, the first target brightness interval includes a 1^{st} first target brightness, a 2^{nd} first target brightness . . . an (n−1)^{th} first target brightness, and an n^{th} first target brightness. The 1^{st} first target brightness is the target brightness of the display device displaying with the first grayscale in the first display mode, the 2^{nd} first target brightness is the target brightness of the display device displaying with the second grayscale in the first display mode, and the n^{th} first target brightness is the target brightness of the display device displaying with the n^{th} grayscale in the first display mode. The higher the grayscale value, the higher the brightness. Accordingly, the maximum target brightness in the first target brightness interval should be understood as the n^{th} first target brightness corresponding to the n^{th} grayscale.

For example, in order to make a display effect of the display device conform to human visual perception, a relationship between an input grayscale and the corresponding brightness value needs to be set so that the brightness value is proportional to the γ power of the grayscale, and the relationship between the grayscale brightness value and the grayscale is referred to as a gamma curve of the display device. For example, a value of γ may be set to 2.2±0.2 so that a display screen is close to what human eyes actually see. Gamma tuning for the display device is performed based on a gamma curve with a set γ value (e.g., 2.2) for the entire grayscale interval, and the target brightness corresponding to each grayscale is calculated according to the gamma curve with the set γ value (e.g., 2.2).

For example, the step of acquiring the first target brightness interval and the first grayscale interval in the first display mode may include:
setting the first maximum target brightness in the first display mode, where the first maximum target brightness is the n^{th} first target brightness corresponding to the n^{th} grayscale; and
calculating the target brightness corresponding to each grayscale based on the first maximum target brightness according to the target brightness being proportional to the γ power of the grayscale.

For example, the display device has 256 grayscale levels, and n is 256.

In step S1020, gamma tuning is performed for a plurality of first target brightness in the first target brightness interval and a plurality of grayscales in the first grayscale interval to obtain a first set of gamma values, where the first set of gamma values includes n first gamma values, the n first gamma values include an i^{th} first gamma value mapping an i^{th} first target brightness in the first brightness interval and an i^{th} grayscale in the first grayscale interval, n is a positive integer greater than or equal to 2, and i is a positive integer greater than or equal to 1 and less than or equal to n.

The first set of gamma values includes a first gamma value mapping the first brightness in the first brightness interval and the first grayscale in the first grayscale interval, a second gamma value mapping the second brightness in the first brightness interval and the second grayscale in the first grayscale interval . . . and an n^{th} gamma value mapping the n^{th} brightness in the first brightness interval and the n^{th} grayscale in the first grayscale interval.

For example, the gamma value obtained by tuning should be understood as a code associated with a data voltage. For example, the number of bits of gamma tuning may be 12, that is, there are a total of 4096 (2¹²) gamma values, specifically including integers from 0 to 4095. Each gamma value is associated with a specific data voltage, and the data voltage and the gamma value are linearly proportional. Data voltage=VGMP−(4095−gamma value)/4095*(VGMP−VGSP), where VGMP is a maximum value of the data voltage, VGSP is a minimum value of the data voltage.

For example, VGMP=7.2V, and VGSP=1V.

In step S1030, a second target brightness interval and a second grayscale interval in a second display mode are acquired, where a maximum target brightness in the second target brightness interval is a second maximum target brightness, and the second maximum target brightness is less than the first maximum target brightness.

It should be noted that because the area of the first display region corresponding to the first display mode is less than the area of the second display region corresponding to the second display mode, the maximum target brightness in the first display mode is greater than the maximum target brightness in the second display mode.

For example, the second grayscale interval may be the same as the first grayscale interval, and the second grayscale interval includes the first grayscale, the second grayscale . . . the (n−1)^{th} grayscale and the n^{th} grayscale. The first grayscale has a grayscale value of 0, the second grayscale has a grayscale value of 1, and the n^{th} grayscale has a grayscale value of n−1.

For example, the second target brightness interval includes a 1^{st} second target brightness, a 2^{nd} second target brightness . . . an (n−1)^{th} second target brightness, and an n^{th} second target brightness. The 1^{st} second target brightness is the target brightness of the display device displaying with the first grayscale in the second display mode, the 2^{nd} second target brightness is the target brightness of the display device displaying with the second grayscale in the second display mode, and the n^{th} second target brightness is the target brightness of the display device displaying with the n^{th} grayscale in the second display mode. The higher the grayscale value, the higher the brightness. Accordingly, the maximum target brightness in the second target brightness interval should be understood as the n^{th} second target brightness corresponding to the n^{th} grayscale.

For example, the step of acquiring the first target brightness interval and the first grayscale interval in the first display mode may include:
setting the second maximum target brightness in the second display mode, where the second maximum target brightness is the n^{th} second target brightness corresponding to the n^{th} grayscale; and
calculating the target brightness corresponding to each grayscale based on the second maximum target brightness according to the target brightness being proportional to the γ power of the grayscale.

In step S1040, a second set of gamma values is calculated based on the first set of gamma values, for a plurality of target brightness in the second target brightness interval and a plurality of grayscales in the second grayscale interval, according to a relationship between the first target brightness interval and the second target brightness interval, where the calculating the second set of gamma values based on the first set of gamma values includes: determining an i^{th} first gamma value corresponding to an i^{th} grayscale in the first grayscale interval as a j^{th} second gamma value corresponding to a j^{th} grayscale in the second grayscale interval, where j is a positive integer greater than or equal to 1 and less than or equal to n, and i is not equal to j.

In the gamma tuning method for the display device provided in the embodiments of the present disclosure, the gamma tuning is firstly performed for the first target brightness interval and the first grayscale interval in the first display mode of the display device to obtain the first set of gamma values, but no gamma tuning is performed directly for the second display mode of the display device. Then the second set of gamma values is calculated based on the first set of gamma values according to the relationship between the first target brightness interval and the second target brightness interval. The first set of gamma values obtained by tuning is used as the gamma values for the first display mode, and the second set of gamma values obtained by calculation is used as the gamma values for the second display mode. Therefore, for the two different display modes, namely the first display mode and the second display mode, only one set of gamma values needs to be obtained by tuning, so that the time of gamma tuning for the display device may be reduced, and an efficiency of gamma tuning may be improved.

According to some exemplary embodiments, the maximum grayscale in the second grayscale interval is the n^{th} grayscale, that is, the second grayscale interval is the same as the first grayscale interval, and both have n grayscale levels. Calculating the second set of gamma values based on the first set of gamma values according to the relationship between the first target brightness interval and the second target brightness range includes:
determining an m^{th} first gamma value corresponding to an m^{th} grayscale in the first grayscale interval as an n^{th} second gamma value corresponding to an n^{th} grayscale in the second grayscale interval according to the relationship between the first maximum target brightness and the second maximum target brightness, where m is a positive integer less than n; and
determining the i^{th} first gamma value corresponding to the i^{th} grayscale in the first grayscale interval as the j^{th} second gamma value corresponding to the j^{th} grayscale in the second grayscale interval according to an equation of:

$$i = round [ ( j - 1 ) / ( n - 1 ) \times ( m - 1 ) ] + 1 ,$$

where round ( ) is a rounding function.

According to some exemplary embodiments, m is calculated by an equation of:

$$m = round ( \sqrt[γ]{\frac{Second maximum target brightness}{First maximum target brightness}} \times ( n - 1 ) ) + 1 ;$$

where round ( ) is a rounding function, and a value of 7 ranges from 2.0 to 2.4.

For example, 7 has a value of 2.1, 2.2, or 2.3.

According to some exemplary embodiments, the first grayscale interval includes a first grayscale sub-interval and a second grayscale sub-interval, the first grayscale sub-interval includes the first grayscale to an x^{th} grayscale, and the second grayscale sub-interval includes an (x+1)^{th} grayscale to the n^{th} grayscale, where x is an integer greater than or equal to 2 and less than or equal to n−1;

Performing gamma tuning for the plurality of target brightness in the first target brightness interval and the plurality of grayscale in the first grayscale interval includes:

driving the display device to display using a third display region, and performing gamma tuning for a plurality of grayscales in the first grayscale sub-interval respectively; and driving the display device to display using a fourth display region, and performing gamma tuning for a plurality of grayscales in the second grayscale sub-interval respectively. An area of the third display region is greater than an area of the fourth display region.

Here, the first grayscale interval is further divided into the first grayscale sub-interval and the second grayscale sub-interval. The first grayscale sub-interval is a low-grayscale interval. For the first grayscale sub-interval, tuning based on the third display region having a larger area may help ensure an accuracy of full-screen optical parameters. The second grayscale sub-interval is a high-grayscale interval. For the second grayscale sub-interval, tuning based on the fourth display region having a smaller area may be closer to tuning based on an actual area used in the first display mode, so as to improve the accuracy of tuning.

According to some exemplary embodiments, x is calculated by an equation of:

$$x = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the area of the third display region is equal to the area of the second display region.

For example, the third display region and the fourth display region are both the entire display region, that is, the area of the third display region and the area of the fourth display regions are both 100%*the area of the entire display region.

According to some exemplary embodiments, the area of the fourth display region is equal to the area of the first display region.

For example, the area of the fourth display region and the first display region are both part of the entire display region. For example, the area of the fourth display region and the area of the first display region are both 1%, 2%, 3%, 4%, 5%, 6%, 7%, or 8% of the area of the entire display region.

It should be noted that when the area of the fourth display region is equal to the area of the first display region, the fourth display region coincides with the first display region, or the fourth display region partially overlaps with the first display region, or the fourth display region does not overlap with the first display region. The fourth display region is generally located in a center of the entire display region.

According to some exemplary embodiments, the area of the fourth display region is larger than the area of the first display region. Upon an actual test, if gamma tuning is performed based on the fourth display region having a slightly larger area, the maximum brightness that may be actually achieved by the display device in the first mode is slightly higher than the first maximum target brightness, that is, a higher brightness may be achieved, and an offset of color coordinates may still meet the specifications.

According to some exemplary embodiments, driving the display device to display using the third display region may further include compensating a voltage signal of the third display region by using a first voltage drop compensation parameter, and driving the display device to display using the fourth display region may further include compensating a voltage signal of the fourth display region by using a second voltage drop compensation parameter. The first voltage drop compensation parameter is greater than the second voltage drop compensation parameter.

Specifically, when the gamma tuning is performed based on the fourth display region having a smaller area, the second voltage drop compensation parameter may be set to be less than the first voltage drop compensation parameter, so that the voltage drop compensation parameter may be appropriately reduced. It may be understood as that a compensation value for the voltage signal of the fourth display region is appropriately reduced, and a load of the display panel is used, which may help achieve higher display brightness.

According to some exemplary embodiments, driving the display device to display using the fourth display region and performing gamma tuning for the plurality of grayscales in the second grayscale sub-interval respectively may include at least:

driving the display device to display using the fourth display region and compensating the voltage signal of the fourth display region by using an a^{th} second voltage drop compensation parameter, and performing gamma tuning for an a^{th} grayscale; and driving the display device to display using the fourth display region and compensating the voltage signal of the fourth display region by using a b^{th} second voltage drop compensation parameter, and performing gamma tuning for a b^{th} grayscale, where x+1≤a<b≤n, a and b are integers, and the a^{th} second voltage drop compensation parameter is greater than the b^{th} second voltage drop compensation parameter.

Here, in the second grayscale sub-interval, with the increase of the grayscale value, a size of the corresponding second voltage drop compensation parameter decreases to meet continuity of tuning results.

According to some exemplary embodiments, performing gamma tuning for the plurality of target brightness in the first target brightness interval and the plurality of grayscales in the first grayscale interval to obtain the first set of gamma values includes: determining at least two binding point grayscales in the first grayscale interval, and determining remaining grayscales other than the binding point grayscales as non-binding point grayscales; performing gamma tuning for each binding point grayscale to obtain a gamma value, so that a difference between a display brightness and a target brightness at the binding point grayscale of the display device is less than a predetermined value; and calculating a gamma value of each non-binding point grayscale according to the gamma value of each binding point grayscale.

For example, the binding point grayscale may be set for gamma tuning according to Table 1.

TABLE 1

| | | | Target bright- | Voltage drop |
|---|---|---|---|---|
| Binding point | | Tuning | ness of binding | compensation |
| grayscale | | region | point | parameter |
| Second | 255 | Fourth display | L1max | Second voltage |
| grayscale | | region | | drop |
| sub- | | | | compensation |
| interval | | | | parameter |
| | Z₁^{th} | Fourth display | L1max*(Z₁ − | Second voltage |
| | grayscale | region | 1/255)^{2.2} | drop |
| | | | | compensation |
| | | | | parameter |
| | Z₂^{th} | Fourth display | L1max*(Z₂ − | Second voltage |
| | grayscale | region | 1/255)^{2.2} | drop |
| | | | | compensation |
| | | | | parameter |
| | Z₃^{th} | Fourth display | L1max*(Z₃ − | Second voltage |
| | grayscale | region | 1/255)^{2.2} | drop |
| | | | | compensation |
| | | | | parameter |
| First | Z₄^{th} | Third display | L1max*(Z₄ − | First voltage |
| grayscale | grayscale | region | 1/255)^{2.2} | drop |
| sub- | | | | compensation |
| interval | | | | parameter |
| | Z₅^{th} | Third display | L1max*(Z₅ − | First voltage |
| | grayscale | region | 1/255)^{2.2} | drop |
| | | | | compensation |
| | | | | parameter |

where L1max represents the first maximum target brightness, the Z1th grayscale, the Z2th grayscale and the Z3th grayscale are selected from any grayscale in the second grayscale sub-interval, and the Z4th grayscale and the Z5th grayscale are selected from any grayscale in the first grayscale sub-interval.

According to some exemplary embodiments, performing gamma tuning for each binding point grayscale to obtain a gamma value includes: performing gamma tuning for the binding point grayscales sequentially according to an ascending order of grayscale values.

For example, referring to Table 1, the binding point grayscales include the Z₅^{th} grayscale, the Z₄^{th} grayscale, the Z₃^{th} grayscale, the Z₂^{th} grayscale, the Z₁^{th} grayscale and 255 (the 256^{th} grayscale) in an ascending order. Accordingly, the gamma tuning is performed for the Z5^{th} grayscale, the Z₄^{th} grayscale, the Z₃^{th} grayscale, the Z₂^{th} grayscale, the Z₁^{th} grayscale and the 256^{th} grayscale sequentially.

The inventors found that it is difficult for the display device to achieve a stability of the display brightness in a short time in a case of a high-brightness display screen corresponding to a high grayscale value, and a brightness attenuation of the display screen may be obvious during gamma tuning, which may affect the accuracy of gamma tuning. Therefore, the gamma tuning may be performed for the binding point grayscales sequentially according to an ascending order of grayscale values, so that the display device may gradually transition from a low display brightness to a high display brightness, and when gamma tuning is performed for a high grayscale, it may be ensured that the brightness of the display device in an instantaneous state during tuning is basically equal to the brightness in an actual steady state, and then the accuracy of gamma tuning is ensured.

Upon actual test, when the gamma tuning is performed for grayscale of 255 to grayscale of 0, the gamma tuning may be completed normally. However, when the display device is lit up again for chromaticity test, the y value in the color coordinates under high grayscale display screen is low, indicating a certain degree of color deviation; when the gamma tuning is performed for grayscale of 0 to grayscale of 255, after the gamma tuning is completed and the display device is lit up again for chromaticity test, the measured color coordinates meet the required specifications.

According to some exemplary embodiments, the display brightness is measured by a brightness testing module. The target brightness of a maximum binding point grayscale is less than an upper limit of a testing range of the brightness testing module to avoid a problem that the brightness testing module crashes due to exceeding the range during brightness test and then the gamma tuning is interrupted.

According to some exemplary embodiments, a gamma value corresponding to a non-binding point grayscale higher than the maximum binding point grayscale is obtained through interpolation calculation according to the corresponding gamma value of each binding point grayscale.

For example, continuing to refer to Table 1, the predetermined binding point grayscales include the Z₅^{th} grayscale, the Z₄^{th} grayscale, the Z₃^{th} grayscale, the Z₂^{th} grayscale, the Z₁^{th} grayscale and 255 (the 256^{th} grayscale) in an ascending order, where the target brightness corresponding to the Z₅^{th} grayscale, the target brightness corresponding to the Z₄^{th} grayscale and the target brightness corresponding to the Z₃^{th} grayscale are less than the upper limit of the testing range of the brightness testing module, and the target brightness corresponding to the Z₂^{th} grayscale, the target brightness corresponding to the Z₁^{th} grayscale and the target brightness corresponding to 255 (the 256^{th} grayscale) are greater than the upper limit of the testing range of the brightness testing module. Therefore, the binding point grayscales may be adjusted to include the Z₅^{th} grayscale, the Z₄th grayscale and the Z₃^{th} grayscale. After the gamma tuning, gamma values A, B and C respectively corresponding to the Z₅^{th} grayscale, the Z₄^{th} grayscale and the Z₃^{th} grayscale may be obtained.

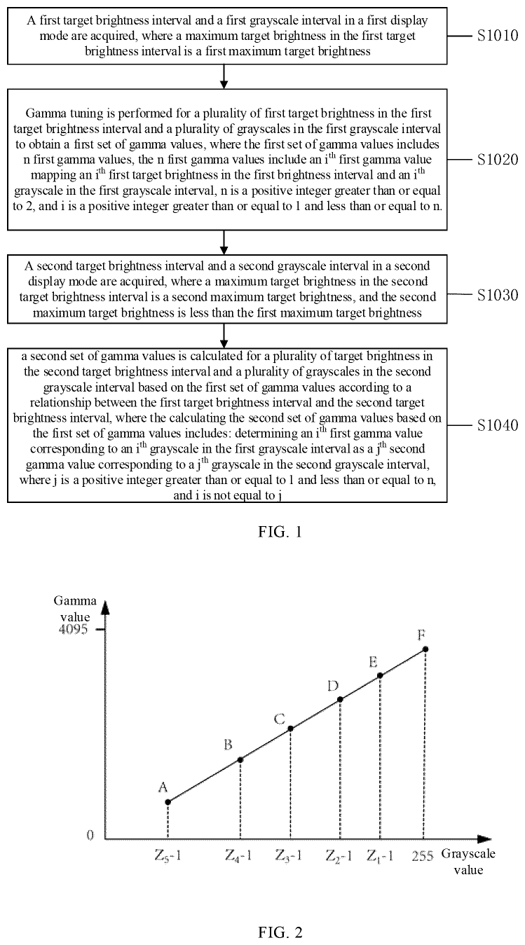

FIG. 2 shows a schematic diagram of a principle of interpolation calculation used in the gamma tuning method for the display device according to the embodiments of the present disclosure.

Referring to FIG. 2, gamma values D, E and F for the Z₂^{th} grayscale, the Z₁^{th} grayscale and the grayscale of 255 (the 256^{th} grayscale) may be calculated through interpolation calculation according to A, B and C. The specific expressions are as follows:

$$D = C + round [ ( C - B ) / ( {Z}_{3} - {Z}_{4} ) \times ( {Z}_{2} - {Z}_{3} ) ] ;$$

$$E = C + round [ ( C - B ) / ( {Z}_{3} - {Z}_{4} ) \times ( {Z}_{1} - {Z}_{3} ) ] ;$$

$$F = C + round [ ( C - B ) / ( {Z}_{3} - {Z}_{4} ) \times ( 256 - {Z}_{3} ) ] ;$$

where round represents a rounding function.

According to some exemplary embodiments, a brightness attenuation module performs a brightness attenuation on a light ray emitted by the display device according to a predetermined brightness attenuation coefficient before the light ray is emitted to the brightness testing module, and a product of the target brightness of the maximum binding point grayscale and the brightness attenuation coefficient is less than the upper limit of the testing range of the brightness testing module.

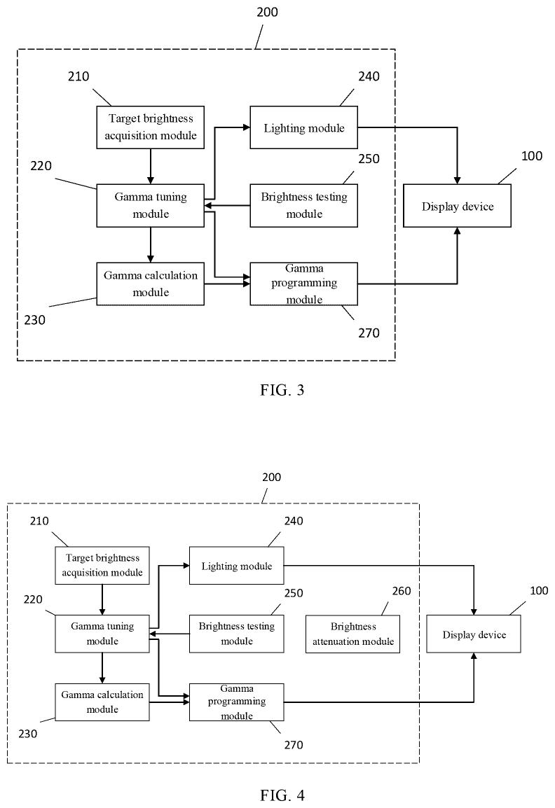

FIG. 3 shows a schematic diagram of a gamma tuning device for a display device according to the embodiments of the present disclosure.

Referring to FIG. 3, a gamma tuning device for a display device is provided. The display device 100 has a first display mode and a second display mode. The display device uses a first display region to display in the first display mode, and uses a second display region to display in the second display mode. An area of the first display region is less than an area of the second display region.

The gamma tuning device 200 includes a target brightness acquisition module 210, a gamma tuning module 220, and a gamma calculation module 230.

The target brightness acquisition module 210 is used to acquire a first target brightness interval and a first grayscale interval in the first display mode and a second target brightness interval and a second grayscale interval in the second display mode. A maximum target brightness in the first target brightness interval is a first maximum target brightness, and a maximum target brightness in the second target brightness interval is a second maximum target brightness. The second maximum target brightness is less than the first maximum target brightness.

The gamma tuning module 220 is electrically connected to the target brightness acquisition module 210. The gamma tuning module 220 may receive the first target brightness interval and the first grayscale interval in the first display mode and the second target brightness interval and the second grayscale interval in the second display mode that are acquired by the target brightness acquisition module 210, and perform gamma tuning on the display device 100 for a plurality of target brightness in the first target brightness interval and a plurality of grayscales in the first grayscale interval to obtain a first set of gamma values. The first set of gamma values is used as gamma values for the first display mode. The first set of gamma values includes n gamma values, and the n gamma values include an i^{th} gamma value mapping an i^{th} brightness in the first brightness interval and an i^{th} grayscale in the first grayscale interval, where n is a positive integer greater than or equal to 2, and i is a positive integer greater than or equal to 1 and less than or equal to n.

The gamma calculation module 230 is electrically connected to the gamma tuning module 220. The gamma calculation module 230 may acquire the first set of grayscale values obtained by gamma tuning of the gamma tuning module 220, and calculate a second set of gamma values based on the first set of gamma values, for a plurality of target brightness in the second target brightness interval and a plurality of grayscales in the second grayscale interval, according to a relationship between the first target brightness interval and the second target brightness interval. Calculating the second set of gamma values based on the first set of gamma values includes: determining the i^{th} gamma value corresponding to the i^{th} grayscale in the first grayscale interval as a j^{th} gamma value corresponding to a j^{th} grayscale in the second grayscale interval, where j is a positive integer greater than or equal to 1 and less than or equal to n, and i is not equal to j.

According to some exemplary embodiments, the maximum grayscale in the second grayscale interval is the n^{th} grayscale.

The gamma calculation module 230 calculating the second set of gamma values based on the first set of gamma values according to the relationship between the first target brightness interval and the second target brightness interval may specifically include:
the gamma calculation module 230 determining an m^{th} first gamma value corresponding to an m^{th} grayscale in the first grayscale interval as an n^{th} second gamma value corresponding to an n^{th} grayscale in the second grayscale interval according to the relationship between the first maximum target brightness and the second maximum target brightness, where m is a positive integer less than n; and
the gamma calculation module 230 determining the i^{th} first gamma value corresponding to the i^{th} grayscale in the first grayscale interval as the j^{th} second gamma value corresponding to the j^{th} grayscale in the second grayscale interval according to an equation of:

$$i = round [ ( j - 1 ) / ( n - 1 ) \times ( m - 1 ) ] + 1 ,$$

where round ( ) is a rounding function.

According to some exemplary embodiments, the gamma calculation module 230 may calculate m by an equation of:

$$m = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the gamma tuning module 220 is further used to divide the first grayscale interval into a first grayscale sub-interval and a second grayscale sub-interval. The first grayscale sub-interval includes the first grayscale to an x^{th} grayscale, and the second grayscale sub-interval includes an (x+1)^{th} grayscale to the n^{th} grayscale, where x is an integer greater than or equal to 2 and less than or equal to n−1.

Continuing to refer to FIG. 3, the gamma tuning device further includes a lighting module 240 electrically connected to the gamma tuning module 220 and the display device 100 respectively. The lighting module 240 is used to acquire the grayscale value for which the gamma tuning module 220 is currently tuning, and drive the display device 100 to display a predetermined screen according to that grayscale value. For example, if the tuning is currently performed for grayscale value of 255, the lighting module 240 drives the display device 100 to display all sub-pixels in the test screen with the grayscale of 255.

The gamma tuning module 220 performing gamma tuning for the plurality of target brightness in the first target brightness interval and the plurality of grayscales in the first grayscale interval specifically includes: the lighting module 240 driving the display device 100 to display using a third display region, and the gamma tuning module 220 performing gamma tuning for a plurality of grayscales in the first grayscale sub-interval respectively; and the lighting module 240 driving the display device 100 to display using a fourth display region, and the gamma tuning module 220 performing gamma tuning respectively for a plurality of grayscales in the second grayscale sub-interval, where an area of the third display region is greater than that of the fourth display region.

According to some exemplary embodiments, the gamma tuning module 220 is further used to calculate x by an equation of:

$$x = round ( \sqrt[γ]{\frac{Second maximum target brightness}{First maximum target brightness}} \times ( n - 1 ) ) + 1 ;$$

where round ( ) is a rounding function, and a value of γ ranges from 2.0 to 2.4.

According to some exemplary embodiments, the area of the third display region is equal to the area of the second display region.

According to some exemplary embodiments, the area of the fourth display region is greater than the area of the first display region.

According to some exemplary embodiments, the area of the fourth display region is equal to the area of the first display region.

According to some exemplary embodiments, the lighting module 240 driving the display device 100 to display using the third display region further includes compensating a voltage signal of the third display region by using a first voltage drop compensation parameter; and the lighting module 240 driving the display device 100 to display using the fourth display region further includes compensating a voltage signal of the fourth display region by using a second voltage drop compensation parameter, where the first voltage drop compensation parameter is greater than the second voltage drop compensation parameter.

According to some exemplary embodiments, the lighting module 240 driving the display device 100 to display using the fourth display region and the gamma tuning module 220 performing gamma tuning for the plurality of grayscales in the second grayscale sub-interval respectively may include at least: the lighting module 240 driving the display device 100 to display using the fourth display region and compensating the voltage signal of the fourth display region by using an a^{th} second voltage drop compensation parameter, and the gamma tuning module 220 performing gamma tuning for an a^{th} grayscale; and the lighting module 240 driving the display device to display using the fourth display region and compensating the voltage signal of the fourth display region by using a b^{th} second voltage drop compensation parameter, and the gamma tuning module 220 performing gamma tuning for a b^{th} grayscale, where x+1≤a<b≤n, a and b are integers, and the a^{th} second voltage drop compensation parameter is greater than the b^{th} second voltage drop compensation parameter.

According to some exemplary embodiments, continuing to refer to FIG. 3, the gamma tuning device further includes a brightness testing module 250 electrically connected to the gamma tuning module 220. The brightness testing module 250 is used to perform a brightness test on the display device 100 in the process of gamma tuning, and transmit a measured display brightness to the gamma tuning module 220.

The gamma tuning module 220 is further used to determine at least two binding point grayscales in the first grayscale interval, and determine remaining grayscales other than the binding point grayscale as non-binding point grayscales.

The gamma tuning module 220 performing gamma tuning for the plurality of target brightness in the first target brightness interval and the plurality of grayscales in the first grayscale interval to obtain the first set of gamma values includes: the gamma tuning module 220 performing gamma tuning for each binding point grayscale to obtain a gamma value, so that a difference between a display brightness and a target brightness at the binding point grayscale of the display device is less than a predetermined value; and the gamma tuning module 220 calculating a gamma value of each non-binding point grayscale according to the gamma value of each binding point grayscale.

According to some exemplary embodiments, the gamma tuning module 220 performing gamma tuning for each binding point grayscale to obtain a gamma value includes: the gamma tuning module 220 performing gamma tuning for the binding point grayscales sequentially according to an ascending order of grayscale values.

According to some exemplary embodiments, the target brightness of a maximum binding point grayscale is less than the upper limit of the testing range of the brightness testing module 250.

According to some exemplary embodiments, the gamma tuning module 220 is further used to obtain a gamma value corresponding to each non-binding point grayscale higher than the maximum binding point grayscale through interpolation calculation according to the gamma value corresponding to each binding point grayscale.

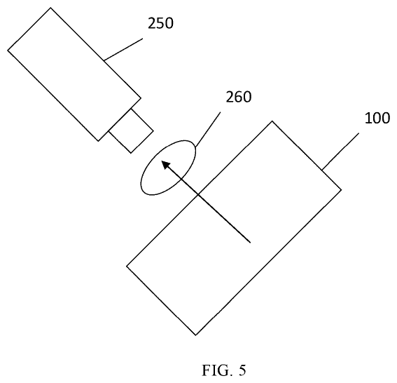

FIG. 4 shows a schematic diagram of another gamma tuning device for a display device according to the embodiments of the present disclosure. FIG. 5 shows a schematic diagram of a principle of a brightness attenuation module performing a brightness attenuation in a gamma tuning device for a display device according to the embodiments of the present disclosure.

According to some exemplary embodiments, referring to FIG. 4 and FIG. 5 in combination, the gamma tuning device 200 further includes a brightness attenuation module 260, which is located between a light-emitting surface of the display device 100 and the brightness testing module 250. The brightness attenuation module 260 performs a brightness attenuation on a light ray emitted by the display device 100 according to a predetermined brightness attenuation coefficient before the light ray is emitted to the brightness testing module 250, and a product of the target brightness of the maximum binding point grayscale and the brightness attenuation coefficient is less than the upper limit of the testing range of the brightness testing module 250.

For example, the brightness attenuation module 260 is a polarizer. The polarizer is arranged parallel above the light-emitting surface of the display device 100, and a polarization direction of the polarizer is set to intersect with a polarization direction of the light rays emitted from the display device 100, thereby achieving a brightness attenuation of the light ray emitted from the display device 100. An angle between the polarization direction of the polarizer and the polarization direction of the light ray emitted from the display device 100 is θ, then the brightness attenuation coefficient is theoretically (cos θ)².

According to some exemplary embodiments, referring to FIG. 3 or FIG. 4, the gamma tuning device 200 further includes a gamma programming module 270. The gamma programming module 270 is electrically connected to the gamma tuning module 220 and the gamma calculation module 230 respectively to acquire the first set of gamma values from the gamma tuning module 220 and acquire the second set of gamma values from the gamma calculation module 230. The gamma programming module 270 is further electrically connected to the display device 100 to program the first set of gamma values and the second set of gamma values into a driver chip of the display device 100.

In another aspect, a display device is provided. The display device includes a display panel and a driver chip bound to the display panel. The driver chip is programmed with the first set of gamma values and the second set of gamma values obtained by tuning of the gamma tuning device provided according to the foregoing embodiments.

The display device has a first display mode and a second display mode. The display device uses a first display region to display in the first display mode and uses a second display region to display in the second display mode. An area of the first display region is less than an area of the second display region. When the display device displays in the first display mode, the first set of gamma values obtained by tuning is called, and when the display device displays in the second display mode, the second set of gamma values obtained by tuning is called.

For example, the first display mode is a high brightness mode, and the second display mode is a local high brightness mode.

According to some exemplary embodiments, the display device further includes a third display mode, which is a high-brightness vivid mode. When the display device displays in the high-brightness vivid mode, the display region of the display device includes a high-brightness vivid display region, the display region of the display device includes a high-brightness vivid display region, a transitional display region and a low-brightness background display region. The transitional display region surrounds a periphery of the high-brightness vivid display region, and the low-brightness background display region surrounds a periphery of the transitional display region.

When the display device displays in the high-brightness vivid mode, the first set of gamma values is called for the high-brightness vivid display region, the second set of gamma values is called for the low-brightness background display region, and a third set of gamma values is called for the transition display region. The third set of gamma values is calculated according to the first set of gamma values.

According to some exemplary embodiments, the step of calculating the third set of gamma values according to the first set of gamma values includes: calculating an equivalent display area according to a screen to be displayed in the high-brightness vivid mode; and calculating the third set of gamma values according to the equivalent display area and the first set of gamma values.

For example, for the third set of gamma values, a k^{th} first gamma value corresponding to a k^{th} grayscale in the first set of gamma values is determined as the gamma value corresponding to the grayscale of 255 in the third set of gamma values, and k is calculated by the following steps:
calculating the corresponding gamma value by calculating an equivalent display brightness corresponding to the grayscale of 255 according to an equation of:

$$Equivalent display brightness = first maximum target brightness - ( first maximum target brightness - second maximum target brightness ) \times ( equivalent display area - area of first display region ) / ( area of second display region - area of first display region ) ;$$

and
calculating k according to an equation of:

$$k = round ( {255}^{*} \sqrt[γ]{\frac{Equivalent display brightness}{First maximum target brightness}} ) + 1 ;$$

where round ( ) is a rounding function, and the value of γ ranges from 2.0 to 2.4.

Here, the terms “substantially”, “about”, “approximately” and other similar terms are used as terms of approximation rather than terms of degree, and they are intended to explain an inherent deviation of a measured or calculated value that will be recognized by those ordinary skilled in the art. Taking into account a process fluctuation, a measurement problem, an error related to a measurement of a specific quantity (that is, a limitation of a measurement system) and other factors, the terms “about” or “approximately” used herein includes a stated value and means that a specific value determined by those ordinary skilled in the art is within an acceptable range of deviation. For example, “about” may mean being within one or more standard deviations, or within ±10% or ±5% of the stated value.

Although some embodiments according to the general inventive concept of the present disclosure have been illustrated and explained, it may be understood by those skilled in the art that changes may be made to these embodiments without departing from the principles and spirit of the general inventive concept of the present disclosure, and the scope of the present disclosure is defined by the claims and their equivalents.

1. A gamma tuning device for a display device, wherein the display device has a first display mode and a second display mode, the display device uses a first display region to display in the first display mode and uses a second display region to display in the second display mode, and an area of the first display region is less than an area of the second display region;
the gamma tuning device comprising:
a target brightness acquisition module configured to acquire a first target brightness interval and a first grayscale interval in the first display mode and a second target brightness interval and a second grayscale interval in the second display mode, a maximum target brightness in the first target brightness interval is a first maximum target brightness, a maximum target brightness in the second target brightness interval is a second maximum target brightness, and the second maximum target brightness is less than the first maximum target brightness;
a gamma tuning module configured to perform gamma tuning for a plurality of target brightness in the first target brightness interval and a plurality of grayscales in the first grayscale interval to obtain a first set of gamma values, wherein the first set of gamma values comprises n gamma values, and the n gamma values comprise an i^{th} gamma value mapping an i^{th} brightness in the first target brightness interval and an i^{th} grayscale in the first grayscale interval, where n is a positive integer greater than or equal to 2, and i is a positive integer greater than or equal to 1 and less than or equal to n; and
a gamma calculation module configured to calculate, for a plurality of target brightness in the second target brightness interval and a plurality of grayscales in the second grayscale interval, a second set of gamma values based on the first set of gamma values according to a relationship between the first target brightness interval and the second target brightness interval, wherein the calculating a second set of gamma values based on the first set of gamma values comprises: determining the i^{th} gamma value corresponding to the i^{th} grayscale in the first grayscale interval as a j^{th} gamma value corresponding to a j^{th} grayscale in the second grayscale interval, where j is a positive integer greater than or equal to 1 and less than or equal to n, and i is not equal to j.

2. The gamma tuning device for the display device according to claim 1, wherein a maximum grayscale in the second grayscale interval is an n^{th} grayscale; and
wherein the gamma calculation module is configured to calculate a second set of gamma values based on the first set of gamma values according to a relationship between the first target brightness interval and the second target brightness interval by:
determining, by the gamma calculation module, an m^{th} first gamma value corresponding to an m^{th} grayscale in the first grayscale interval as an n^{th} second gamma value corresponding to an n^{th} grayscale in the second grayscale interval according to a relationship between the first maximum target brightness and the second maximum target brightness, where m is a positive integer less than n; and
determining, by the gamma calculation module, the i^{th} first gamma value corresponding to the i^{th} grayscale in the first grayscale interval as the j^{th} second gamma value corresponding to the j^{th} grayscale in the second grayscale interval according to an equation of:
$$i = round [ ( j - 1 ) / ( n - 1 ) \times ( m - 1 ) ] + 1 ,$$
where round ( ) is a rounding function.

3. The gamma tuning device for the display device according to claim 2, wherein the gamma calculation module is configured to calculate m according to an equation of:
$$m = round ( \sqrt[γ]{\frac{Second maximum target brightness}{First maximum target brightness}} \times ( n - 1 ) ) + 1 ;$$
where round ( ) is a rounding function, and a value of γ ranges from 2.0 to 2.4.

4. The gamma tuning device for the display device according to claim 1, wherein the gamma tuning module is further configured to divide the first grayscale interval into a first grayscale sub-interval and a second grayscale sub-interval, the first grayscale sub-interval comprises a first grayscale to an x^{th} grayscale, the second grayscale sub-interval comprises an (x+1)^{th} grayscale to an n^{th} grayscale, and x is an integer greater than or equal to 2 and less than or equal to n−1;
wherein the gamma tuning device further comprises a lighting module configured to drive the display device to display a predetermined screen; and
wherein the gamma tuning module is configured to perform gamma tuning for a plurality of target brightness in the first target brightness interval and a plurality of grayscales in the first grayscale interval by:
driving, by the lighting module, the display device to display using a third display region, and performing, by the gamma tuning module, gamma tuning respectively for a plurality of grayscales in the first grayscale sub-interval; and
driving, by the lighting module, the display device to display using a fourth display region, and performing, by the gamma tuning module, gamma tuning respectively for a plurality of grayscales in the second grayscale sub-interval,
wherein an area of the third display region is greater than an area of the fourth display region.

5. The gamma tuning device for the display device according to claim 4, wherein the gamma tuning module is further configured to calculate x by an equation of:
$$x = round ( \sqrt[γ]{\frac{Second maximum target brightness}{First maximum target brightness}} \times ( n - 1 ) ) + 1 ;$$
where round ( ) is a rounding function, and a value of γ ranges from 2.0 to 2.4.

6. The gamma tuning device for the display device according to claim 4, wherein the area of the third display region is equal to the area of the second display region; and/or
the area of the fourth display region is greater than or equal to the area of the first display region.

7. The gamma tuning device for the display device according to claim 4, wherein the lighting module is configured to drive the display device to display using a third display region by: compensating a voltage signal of the third display region by using a first voltage drop compensation parameter; and
wherein the lighting module is configured to drive the display device to display using a fourth display region by: compensating a voltage signal of the fourth display region by using a second voltage drop compensation parameter, and the first voltage drop compensation parameter is greater than the second voltage drop compensation parameter.

8. The gamma tuning device for the display device according to claim 7, wherein the lighting module is configured to drive the display device to display using a fourth display region and the gamma tuning module is configured to perform gamma tuning respectively for a plurality of grayscales in the second grayscale sub-interval by at least:
driving, by the lighting module, the display device to display using the fourth display region and compensating, by the lighting module, the voltage signal of the fourth display region by using an a^{th} second voltage drop compensation parameter, and performing, by the gamma tuning module, gamma tuning for an a^{th} grayscale; and
driving, by the lighting module, the display device to display using the fourth display region and compensating, by the lighting module, the voltage signal of the fourth display region by using a b^{th} second voltage drop compensation parameter, and performing, by the gamma tuning module, gamma tuning for a b^{th} grayscale,
wherein x+1≤a<b≤n, a and b are integers, and the a^{th} second voltage drop compensation parameter is greater than the b^{th} second voltage drop compensation parameter.

9. The gamma tuning device for the display device according to claim 1, wherein the gamma tuning device further comprises a brightness testing module configured to measure a display brightness of the display device;
wherein the gamma tuning module is further configured to determine at least two binding point grayscales in the first grayscale interval, and determine remaining grayscales other than the binding point grayscales as non-binding point grayscales; and
wherein the gamma tuning module is configured to perform gamma tuning for a plurality of target brightness in the first target brightness interval and a plurality of grayscales in the first grayscale interval to obtain a first set of gamma values by:
performing, by the gamma tuning module, gamma tuning for each binding point grayscale to obtain a gamma value, so that a difference between a display brightness measured by the brightness testing module and a target brightness acquired by the target brightness acquisition module at the binding point grayscale of the display device is less than a predetermined value; and
calculating, by the gamma tuning module, a gamma value of each non-binding point grayscale according to a gamma value of each binding point grayscale.

10. The gamma tuning device for the display device according to claim 9, wherein the gamma tuning module is configured to perform gamma tuning for each binding point grayscale to obtain a gamma value by:
performing, by the gamma tuning module, gamma tuning for the binding point grayscales sequentially in an ascending order of grayscale value.

11. The gamma tuning device for the display device according to claim 9, wherein the target brightness of a maximum binding point grayscale is less than an upper limit value of a testing range of the brightness testing module.

12. The gamma tuning device for the display device according to claim 11, wherein the gamma tuning module is further configured to obtain a gamma value corresponding to each non-binding point grayscale greater than the maximum binding point grayscale through interpolation calculation according to the gamma value corresponding to each binding point grayscale.

13. The gamma tuning device for the display device according to claim 9, wherein the gamma tuning device further comprises a brightness attenuation module between a light-emitting surface of the display device and the brightness testing module, and the brightness attenuation module is configured to perform a brightness attenuation on a light ray emitted by the display device according to a predetermined brightness attenuation coefficient before the light ray is emitted to the brightness testing module; and
wherein a product of the target brightness of a maximum binding point grayscale and the brightness attenuation coefficient is less than an upper limit of a testing range of the brightness testing module.

14. A gamma tuning method for a display device, wherein the display device has a first display mode and a second display mode, the display device uses a first display region to display in the first display mode and uses a second display region to display in the second display mode, and an area of the first display region is less than an area of the second display region;
the gamma tuning method comprising:
acquiring a first target brightness interval and a first grayscale interval in the first display mode, wherein a maximum target brightness in the first target brightness interval is a first maximum target brightness;
performing gamma tuning for a plurality of target brightness in the first target brightness interval and a plurality of grayscales in the first grayscale interval to obtain a first set of gamma values, wherein the first set of gamma values comprises n gamma values, and the n gamma values comprise an i^{th} gamma value mapping an i^{th} brightness in the first target brightness interval and an i^{th} grayscale in the first grayscale interval, where n is a positive integer greater than or equal to 2, and i is a positive integer greater than or equal to 1 and less than or equal to n;
acquiring a second target brightness interval and a second grayscale interval in the second display mode, wherein a maximum target brightness in the second target brightness interval is a second maximum target brightness, and the second maximum target brightness is less than the first maximum target brightness; and
calculating, for a plurality of target brightness in the second target brightness interval and a plurality of grayscales in the second grayscale interval, a second set of gamma values based on the first set of gamma values according to a relationship between the first target brightness interval and the second target brightness interval, wherein the calculating a second set of gamma values based on the first set of gamma values comprises: determining the i^{th} gamma value corresponding to the i^{th} grayscale in the first grayscale interval as a j^{th} gamma value corresponding to a j^{th} grayscale in the second grayscale interval, where j is a positive integer greater than or equal to 1 and less than or equal to n, and i is not equal to j.

15. The gamma tuning method for the display device according to claim 14, wherein a maximum grayscale in the second grayscale interval is an n^{th} grayscale; and
wherein the calculating a second set of gamma values based on the first set of gamma values according to a relationship between the first target brightness interval and the second target brightness interval comprises:
determining an m^{th} first gamma value corresponding to an m^{th} grayscale in the first grayscale interval as an n^{th} second gamma value corresponding to an n^{th} grayscale in the second grayscale interval according to a relationship between the first maximum target brightness and the second maximum target brightness, where m is a positive integer less than n; and
determining the i^{th} first gamma value corresponding to the i^{th} grayscale in the first grayscale interval as the j^{th} second gamma value corresponding to the j^{th} grayscale in the second grayscale interval according to an equation of:
$$i = round [ ( j - 1 ) / ( n - 1 ) \times ( m - 1 ) ] + 1 ,$$
where round ( ) is a rounding function.

16. The gamma tuning method for the display device according to claim 15, wherein m is calculated according to an equation of:
$$m = round ( \sqrt[γ]{\frac{Second maximum target brightness}{First maximum target brightness}} \times ( n - 1 ) ) + 1 ;$$
where round ( ) is a rounding function, and a value of γ ranges from 2.0 to 2.4.

17. The gamma tuning method for the display device according to claim 14, wherein the first grayscale interval comprises a first grayscale sub-interval and a second grayscale sub-interval, the first grayscale sub-interval comprises a first grayscale to an x^{th} grayscale, the second grayscale sub-interval comprises an (x+1)^{th} grayscale to an n^{th} grayscale, and x is an integer greater than or equal to 2 and less than or equal to n−1;
wherein the performing gamma tuning for a plurality of target brightness in the first target brightness interval and a plurality of grayscales in the first grayscale interval comprises:
driving the display device to display using a third display region, and performing gamma tuning respectively for a plurality of grayscales in the first grayscale sub-interval; and
driving the display device to display using a fourth display region, and performing gamma tuning respectively for a plurality of grayscales in the second grayscale sub-interval, wherein an area of the third display region is greater than an area of the fourth display region.

18. The gamma tuning device for the display device according to claim 17, wherein x is calculated by an equation of:
$$x = round ( \sqrt[γ]{\frac{Second maximum target brightness}{First maximum target brightness}} \times ( n - 1 ) ) + 1 ;$$
where round ( ) is a rounding function, and a value of γ ranges from 2.0 to 2.4.

19. A display device, comprising a display panel and a driver chip bound to the display panel, wherein the driver chip is programmed with a first set of gamma values and a second set of gamma values obtained by tuning of the gamma tuning device of claim 1.
